(19) United States
(12) Patent Application Publication
(10) Pub. No.: US 2016/0204644 A1
(43) Pub. Date: Jul. 14, 2016

(54) WIRELESS BATTERY CHARGER

(71) Applicant: SAMSONITE IP HOLDINGS S.ÀR.L., Luxembourg (LU)

(72) Inventors: Jon Karl DUKERSCHEIN, San Francisco, CA (US); Bryan Lee Hynecek, Redwood City, CA (US)

(73) Assignee: Samsonite IP Holdings S.àr.l., Luxembourg (LU)

(21) Appl. No.: 14/913,138

(22) PCT Filed: Aug. 22, 2014
(86) PCT No.: PCT/US2014/052219

§ 371 Date: Feb. 19, 2016

Related U.S. Application Data
(60) Provisional application No. 61/868,699, filed on Aug. 22, 2013.

(51) Int. Cl. H02J 7/02

(52) U.S. Cl. CPC H02J 7/025

(57) ABSTRACT

A system for charging a personal electronic device (“PED”). The system includes a power storage module (or “portable power source”) including a magnetic transfer module, a charging module, and a storage module. The power storage module wirelessly transfers power to the PED via a device interface module, to power a device charging module in the PED.

### CROSS-REFERENCE TO RELATED APPLICATIONS

The present application claims priority to U.S. Provisional Patent Application No. 61/868,699 filed Aug. 22, 2013, entitled “WIRELESS BATTERY CHARGER” the entirety of each of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention relates generally to a wireless battery charging system and methods, and more particularly to a proximity power source to recharge a mobile device or portable electronic device such as a smartphone, tablet computer, portable music player, navigation device, or similar device.

Portable electronic devices (hereinafter “PED” or simply “mobile device”) have become commonplace in today's world. Users wish to utilize portable electronic devices to provide various functions such as telephone and video communications, text-based communication, internet browsing, gaming, music and video playback, navigation, location services, and other features, all of which affect the available battery life of a PED. Due to the limited battery capacity of current batteries, these battery-intensive functions require users of such devices to have access to at least one of the following: spare batteries, external batteries, a fixed power supply such as an AC source via a wall outlet, an AC-DC converter, or an induction mat connected to an AC source or from a DC source such as a USB connection.

Access to an external power source is not always available to a user and a user may not have the time to wait for a PED to recharge. Thus, users may be inconvenienced by having to relocate to an area where an external source is accessible, and/or discontinue use of various functions provided by the mobile device. The users may also have to locate or carry a cable and/or power converter to connect the mobile device to the external source.

In addition, users may be inclined to use devices that have a slim profile and do not want to add a bulky external battery to a mobile device in order to increase the usability of the device, or they may not wish to remain tethered to an external battery source.

Charging cases and charging mats currently exist using magnetic induction technology. Technologies such as magnetic resonance may also be used, as discussed below in more detail. In order to charge a PED utilizing such a device, the PED must be placed on the charging mat, which itself is connected to an external power source. As a result of the magnetic fields created, the internal battery of the PED may be charged through induction. Additionally, as discussed above, portable external batteries exist that may allow a user to connect their PED via cable to a portable power source that allows them to charge a PED while it is connected, or to operate their device while it is connected to the cabled external battery. However, a need exists to combine the cableless connection of wireless charging with the portability of an external battery to provide a user with maximum flexibility and portability. Further there is a need for an external power source that allows the user to not be tethered to a fixed location while charging, thereby providing maximum portability and an easy way to charge PEDs while on the move.

### SUMMARY OF THE INVENTION

In an embodiment, a system is provided for charging a personal electronic device. The system comprises a power storage module (or “portable power source”) comprising a magnetic transfer module, a charging module, and a storage module. The power storage module wirelessly transfers power to the PED via a device interface module, to power a device charging module in the PED.

In an embodiment, a method is provided for charging a PED using an external power module by placing the external power module in proximity to the PED, inducing a magnetic transfer of power from the external power module to the PED, and storing the transferred power in an internal power storage module of the PED.

In an embodiment, the device will charge itself when placed in proximity to a charging source and will then charge PEDs when placed in proximity to them without cables. In an embodiment the portable power source device may need to utilize cable for charging, however the device may have a micro USB port (or comparable port) for charging, e.g., using a traditional cable. In another embodiment, the portable power source may utilize a charging mat, such as a magnetic induction or magnetic resonance charging mat. In another embodiment, the power source may use a cable when a charging mat is not available. In an embodiment, the portable power source may interface through an I/O port to allow for wireless charging, and a charging source (referred to as a mat) to charge the case or battery.

In an embodiment, a mobile device case comprises a wireless receiving system capable of transferring a charge to the internal battery of the PED from a portable battery with a wireless power transmitter and a wireless power receiver, and a charging mat with a wireless transmitter. In an embodiment, the portable battery's transmitter is capable of transmitting power to the wireless power receiver in the case when it is in the general proximity of the case. In an embodiment, the portable battery may be charged when it is in proximity to the charging mat. In another embodiment, the portable battery may directly charge from a DC source. In another embodiment, the portable battery, when connected to a DC source, will transmit power to the internal battery within the device when it is within the proximity of the portable battery before the portable battery charges itself.

In an embodiment, a portable power source does not add bulk to a case used with a PED. Further, the portable power source itself is highly portable and charges a PED via wireless charging, such as magnetic induction or magnetic resonance charging, when in proximity to a mobile device. In an embodiment, this allows for a user to maintain a thin and light case while still gaining the benefit of a portable battery charging pack.

### BRIEF DESCRIPTION OF THE DRAWINGS

The invention is illustrated in the figures of the accompanying drawings, which are meant to be exemplary and not limiting, and in which like references are intended to refer to like or corresponding parts.

FIG. 1 depicts a schematic view of the wireless charging system in accordance with an embodiment of the present disclosure.

FIG. 2 depicts a personal electronic device, a portable battery, and a charging station in accordance with an embodiment of the present disclosure.

FIG. 3 depicts various wireless charging scenarios in accordance with an embodiment of the present disclosure.

FIG. 4 depicts a personal electronic device, a portable battery, and a charging station in accordance with an embodiment of the present disclosure.

FIG. 5 depicts a charging scenario and a use scenario of a personal electronic device and a portable battery in accordance with an embodiment of the present disclosure.

FIG. 6 depicts a personal electronic device and a portable battery in accordance with an embodiment of the present disclosure.

FIG. 7 depicts a personal electronic device in accordance with an embodiment of the present disclosure.

### DETAILED DESCRIPTION

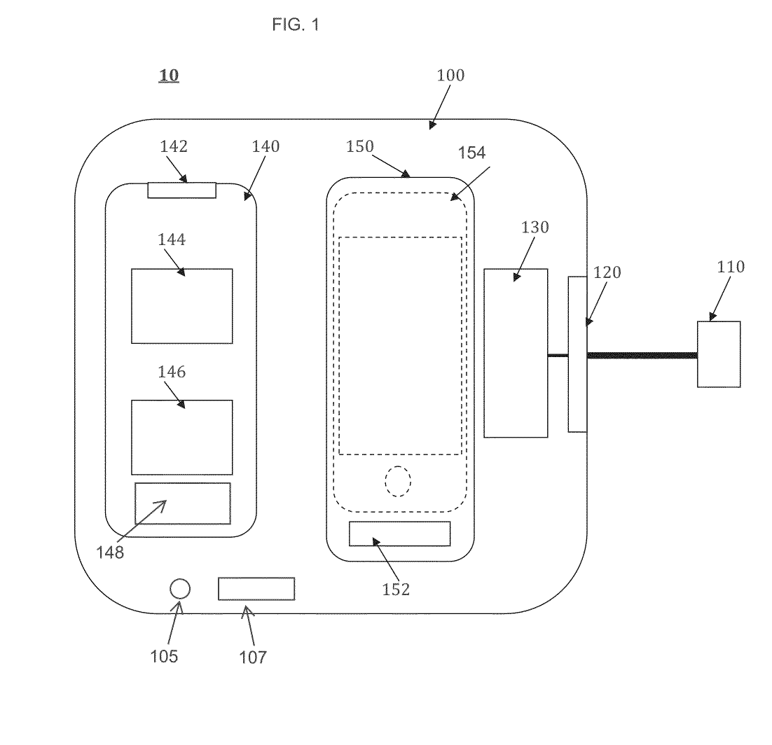

FIG. 1 depicts charging system 10. According to some embodiments, charging system 10 comprises charging area 100 which may comprise a cable interface 120 and a power transmitter module 130. Charging station 100 may also comprise indicator light(s) 105, power switch(es) 107, and a power connector 110. Power pack 140 may comprise external power connector 142, power transmitter module 144, power receiver module 146, and power storage module 148.

In an embodiment, PED case 150 comprises a PED power receiver module 152. PED 154 may be placed within PED case 150 and may have its own internal power storage module, such as a battery. PED 154 may also have a connector that interfaces with PED case 150, such as a USB port, Micro USB port, or Lightning connector.

In an embodiment, charging station 100 may be a charging mat, holder, fixture, or other physical configuration that allows for wireless inductive charging of a PED. Inductive charging (also known as “wireless charging”) uses an electromagnetic field to transfer energy between two objects. In other embodiments, charging station 100 may allow for wireless charging by way of magnetic resonance, including but not limited to Alliance for Wireless Power (A4WP), Power by Proxy, and/or WiTricity, or other methods of wireless charging.

Power connector 110 may be a standard AC power connector with an AC to DC transformer. Additionally, or alternatively, power connector 110 may connect directly to a DC source using for example, a USB connector or any other type of DC power connector such as an automobile auxiliary power connector. Additionally, and/or alternatively, power connector 110 may be an AC connector without a transformer.

According to some embodiments, cable interface 120 may allow for removal of a power cord from charging station 100 and may comprise an AC-DC transformer or other electronics such as surge protection, over voltage protection, under current detection, or thermal protection, etc. Cable interface 120 may be coupled to indicator light(s) 105 and/or switches 107 to indicate the status of the charging station and to control the charging station. Indicator light(s) 105 may be LEDs, or other visual forms of indicators.

In an embodiment using magnetic induction or magnetic resonance, a magnetic field is used as a bridge between power transmitter module 130 in charging station 100 and power receiving module 146 in power pack 140, which can then use that energy to charge a power storage module 148 or to run a mobile device. Charging station 100 may comprise a transmitting coil in the form of power transmitter 130 to create an alternating electromagnetic field from within a charging station 100. A receiving coil in power pack 140 in the form of power receiver module 146 takes power from the electromagnetic field generated by power transmitter module 130 and converts it back into electrical current to charge the power storage module 148. By placing power transmitter module 130 in proximity to power receiver module 146, the two coils combine to form an electrical transformer which provides power to power storage module 148.

In an embodiment, power storage module 148 may be a battery or other storage device and may include galvanic cells, electrolytic cells, fuel cells, flow cells, and/or voltaic piles. The power storage module 148 may be comprised of a Nickel-cadmium (“NiCd” or “NiCad”) battery, a lead-acid battery, a NIMH battery, a NiZn battery, a lithium ion battery, or any other type of rechargeable and or reusable battery.

In an embodiment, power pack 140 may be thought of as a portable power source utilized to charge PED 154 when away from charging station 100. In an embodiment, power pack 140 retains a charge in power storage module 148. By placing power pack 140 with power transmitter module 144 in proximity to PED case 150 with an installed PED, power receiver module 152 and power transmitter 144 combine to form an electrical transformer which provides power to charge the internal battery of PED 154.

According to some embodiments, instead of power receiver module 152 and power transmitter 144 combining to form an electrical transformer to provide power to charge the internal battery of PED 154, the combination may instead, or in addition to, combine to power a separate rechargeable power storage area such as a battery built into PED case 150.

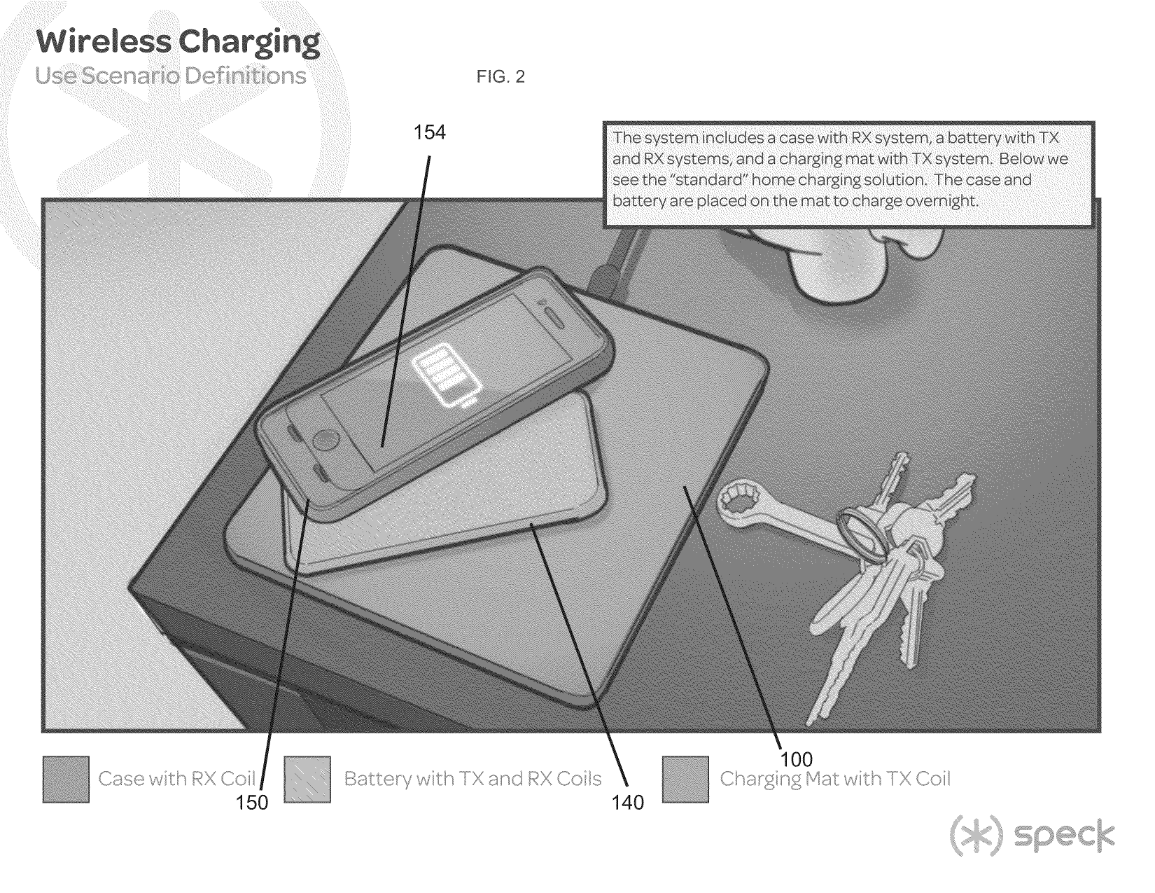

FIG. 2 depicts a personal electronic device, a portable battery, and a charging station in accordance with an embodiment of the present disclosure. According to an embodiment, this figure depicts exemplary use of the charging station 100, power pack 140, and PED case 150 in a “home” environment, i.e., when a user is not away from the base station setting of charging station 100.

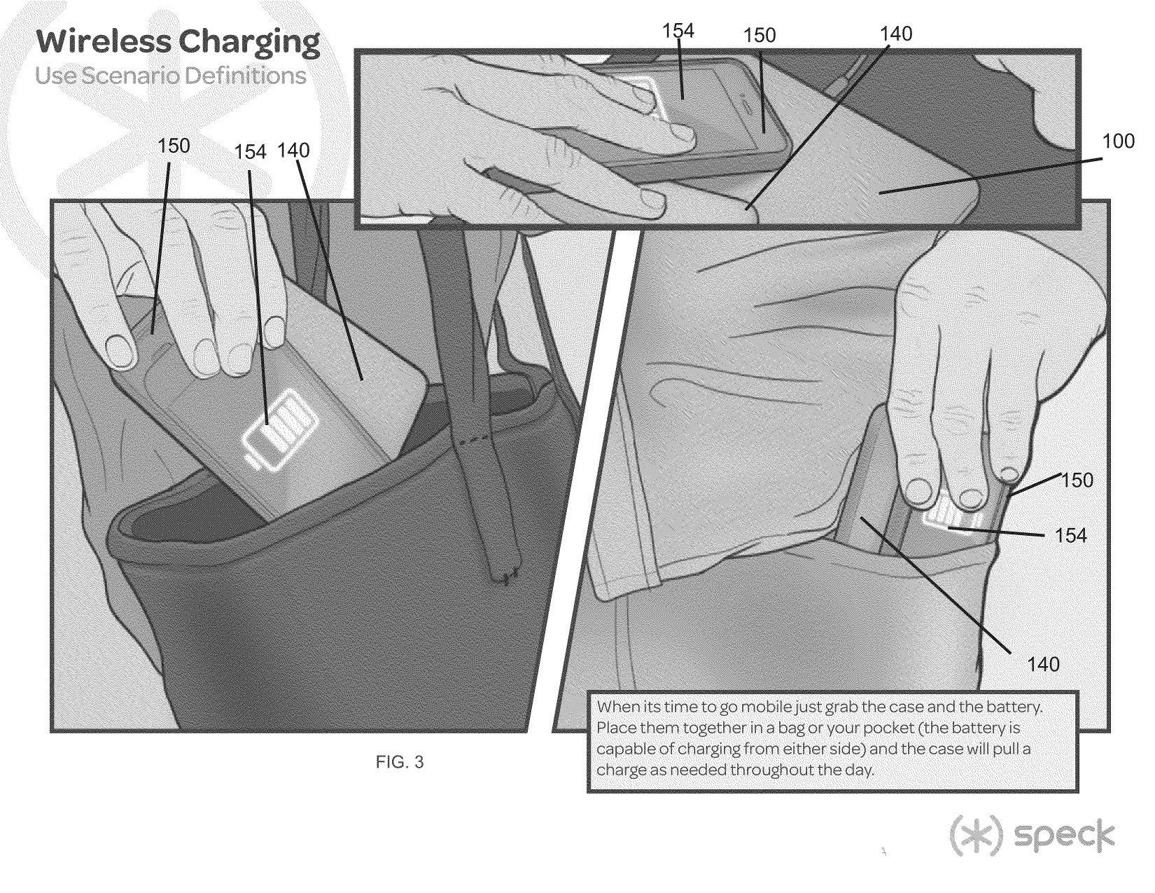

FIG. 3 depicts various wireless charging scenarios in accordance with an embodiment of the present disclosure. According to various embodiments, for example, the power pack 140 and PED case 150 may be transported as a pair and carried in, e.g., a bag or pocket, to wireless charge PED 154. Power pack 140 may be placed on either side of PED 154 and will charge as long as the two are in close proximity.

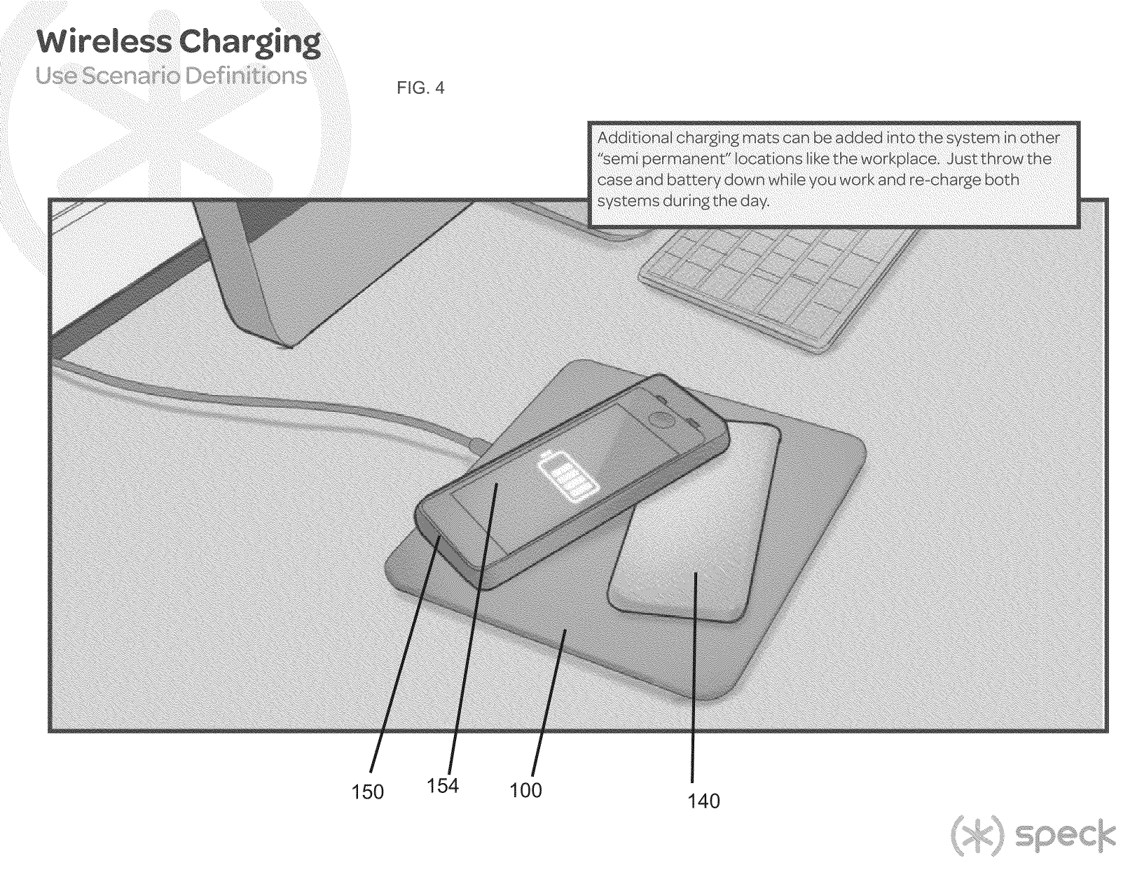

FIG. 4 depicts a personal electronic device, a portable battery, and a charging station in accordance with an embodiment of the present disclosure. In an embodiment, additional charging stations 100 may be placed in areas convenient to the user such as other rooms in a home, in an office, or at other places frequently visited by the user of the PED.

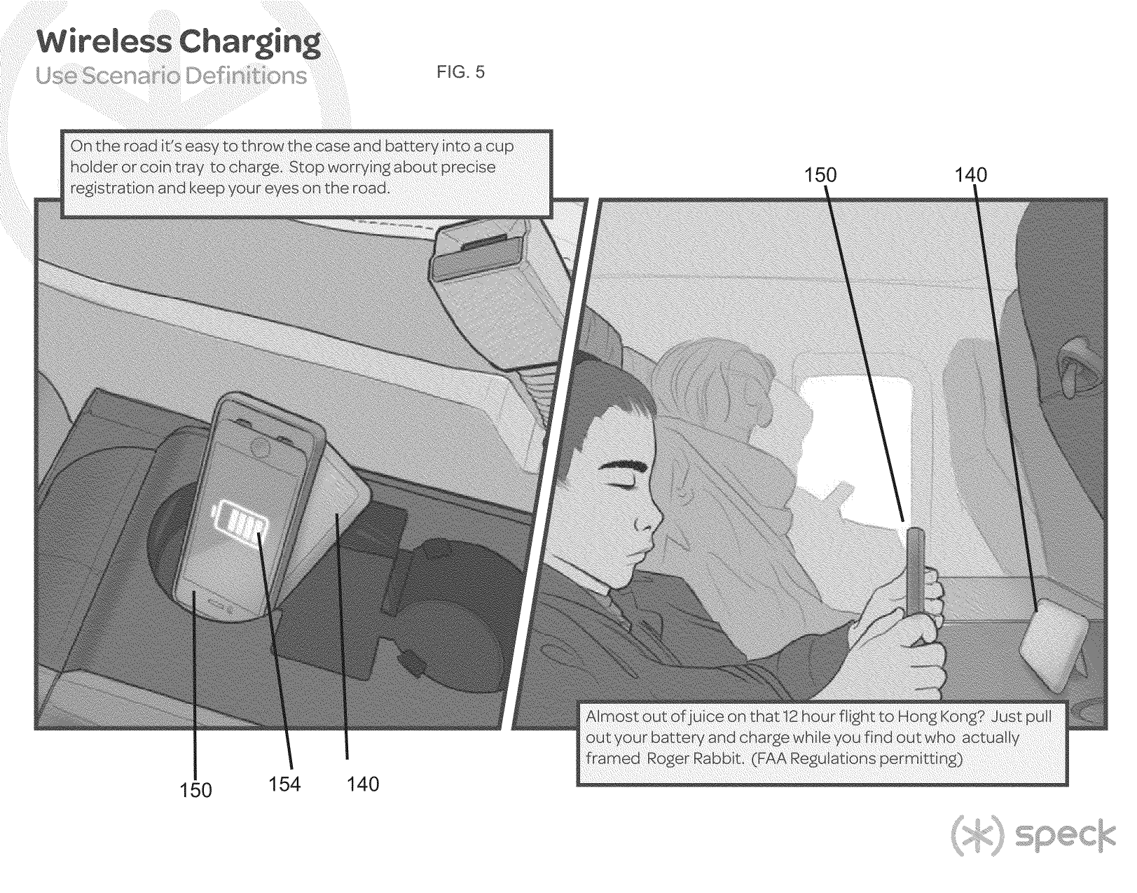

FIG. 5 depicts a charging scenario and a use scenario of a personal electronic device and a portable battery in accordance with an embodiment of the present disclosure. In an embodiment, power pack 140 and PED case 150 may be placed into close proximity to charge PED 154 in almost any environment such as in a car cupholder, or on an airplane (subject to FAA regulations), or virtually any other environment where a PED user may need wireless charging without access to, e.g., a wireless charging mat that requires an external power source such as AC or DC.

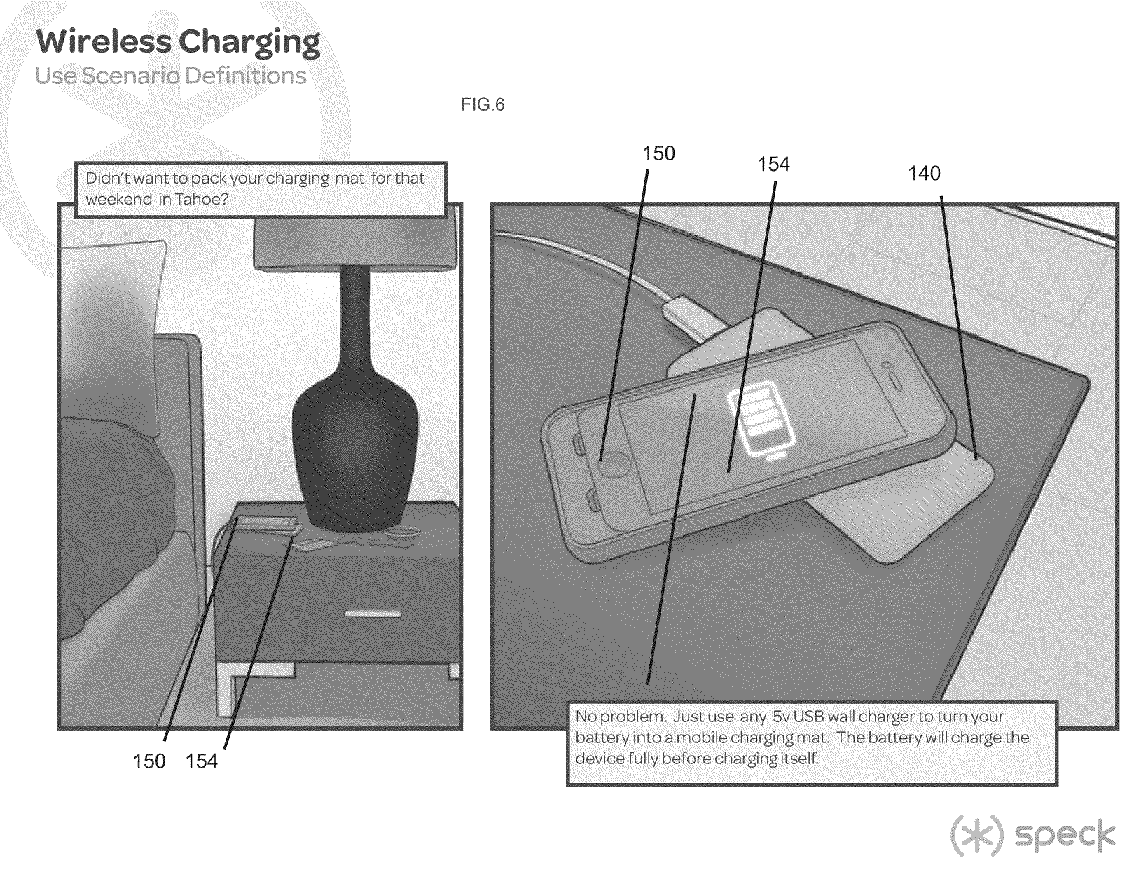

FIG. 6 depicts a personal electronic device and a portable battery in accordance with an embodiment of the present disclosure. In an embodiment, the power pack 140 itself can be used as charging station 100 by use of e.g., a 5 volt USB charger or similar charging cable. Use of the system in this embodiment is particularly useful when a PED user is away from home for an extended period of time and does not have access to charging station 100, but wishes to continually recharge power pack 140 and PED 154, using power pack 140 in place of charging station 100. With respect to FIGS. 2-6, as discussed above, magnetic induction, magnetic resonance, or other wireless transfer technology may be utilized, including those (such as magnetic resonance in particular) aimed at increasing the freedom of positioning devices and/or allowing for multiple devices within a single flux field.

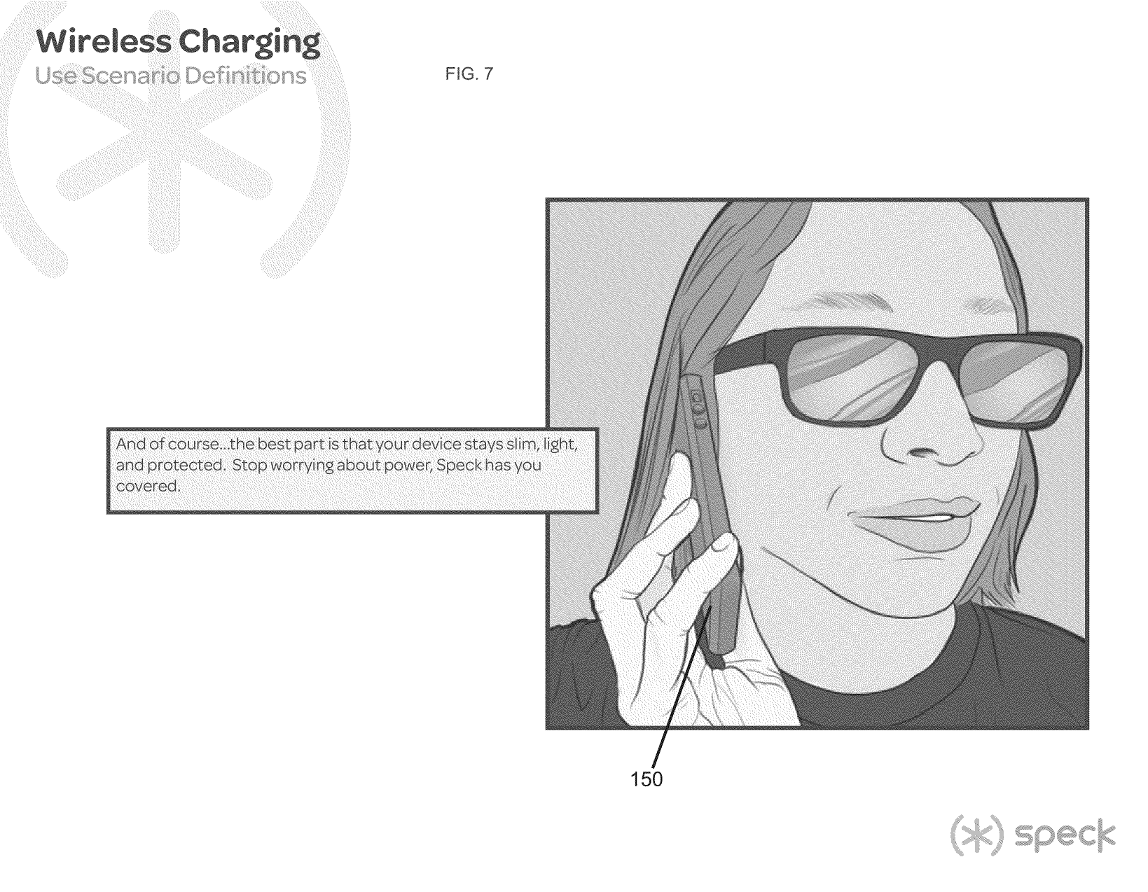

FIG. 7 depicts a personal electronic device in accordance with an embodiment of the present disclosure. According to an embodiment, the size and shape of PED 154 is materially unaffected by PED case 150.

While the invention has been described and illustrated in connection with embodiments, many variations and modifications as will be evident to those skilled in this art may be made without departing from the spirit and scope of the invention as defined by the claims, and the invention is thus not to be limited to the precise details of methodology or construction set forth above as such variations and modifications are intended to be included within the scope of the invention as defined by the claims.

1. A system for charging a personal electronic device comprising:
a portable power storage module comprising:
a magnetic transfer module;
a charging module; and
a storage module;
a device interface module; and
a device charging module,
wherein the power storage module wirelessly transfers power to the personal electronic device via the device interface module.

2. A method for charging a personal electronic device comprising:
charging an external power module;
placing the external power module in proximity to the personal electronic device;
initiating a magnetic transfer of power from the external power module to the personal electronic device; and
storing the transferred power in an internal power storage module of the personal electronic device.
